(19) United States
(12) Patent Application Publication
(10) Pub. No.: US 2008/0066721 A1
(43) Pub. Date: Mar. 20, 2008

(54) DIESEL ENGINE CONVERSION TO USE ALTERNATIVE FUELS

(76) Inventor: Brian Friedman, Los Angeles, CA (US)

Correspondence Address: Lawrence S. Cohen, Attorney, 10960 Wilshire Boulevard, Suite 1220, Los Angeles, CA, 90024, US

(21) Appl. No.: 11/849,231

(22) Filed: Aug. 31, 2007

Related U.S. Application Data
(63) Continuation-in-part of application No. 11/518,371, filed on Sep. 8, 2006.

(51) Int. Cl. F02G 5/02

(52) U.S. Cl. 123/557; 165/52

(57) ABSTRACT

A method and apparatus for converting a diesel engine for running on alternative fuels in which the a combination filter and heater assembly is installed between the fuel supply and the engine including a heat exchanger portion having a path for fuel and for coolant in order to heat the fuel and a shell defining a filter space and arranged so that incoming fuel passes first through the heat exchanger into the shell, then through a filter in the shell, then back through the heat exchanger and then out to the engine. The shell has a lower portion in which impurities collect and can be drained off.

### RELATED APPLICATIONS

This application is a continuation-in-part of application Ser. No. 11/518,371, filed on Sep. 8, 2006 the entire content of which is incorporated herein by reference.

### FIELD OF THE INVENTION

The invention relates to conversion apparatus and methods to allow diesel engines to run with alternative fuels.

### BACKGROUND OF THE INVENTION

Concern about the price and availability of automotive fuel and is ubiquitous. It is possible to convert diesel engines to run on alternative fuels.

Numerous techniques and variations have been developed for such conversions.

Common features of conversion technology address the characteristics of vegetable oils as alternative fuels that differ from diesel oil. Basic recognized general elements for the use of alternative fuels are heating the alternative fuel and filtering. Various approaches to these issues have been implemented.

Heating addresses an important aspect of conversions which is the need to lower the viscosity of the alternative fuel as close as possible to that of diesel fuel. This is done by heating the alternative fuel. In the case of vegetable oil, it is considered that it must be at, at least about 160 degrees ° C. at the point that it is introduced to the injector pump in order that its viscosity be at or near that of diesel fuel.

Prior art devices accomplish this by directing the fuel to a heater just before it is introduced into the injector pump. This approach to addressing the heating issue creates a considerable problem in trying to locate the heater close to the injector pump. It involves the need to attach the heater somewhere where it will be secure, but close to the engine. There are two basic sources of heat. One is hot engine coolant and the other is electrical heating. Each presents problems of its use to heat the alternative fuel. Providing a heater also involves re-routing the fuel lines. Both of these issues, heating and filtering, are problematic to the conversion.

FIG. 1 shows in schematic form the general layout of a stock diesel engine. The term “stock” as used herein means a mechanical item as it is present in an unconverted diesel engine; and usually as original equipment, which is also referred to as OEM equipment. As will be seen later, this diagram is not necessarily inclusive of all elements of a diesel engine. In FIG. 1, the following equipment is shown:

Fuel tank, 10,

Fuel return lines (R), 12, 12a and 12b,

Fuel line from tank to filter, 14,

Fuel line from filter to fuel pump, 14a

Fuel line from fuel pump to injector pump, 14b

Heater core, 16,

Heater hose, 18,

Heater hose, 20,

Engine, 22,

Fuel Injectors (5), 24,

Fuel lines from injector pump, 26,

Injector pump, 28,

Fuel pump 29,

Fuel filter, 30,

Radiator hose, 32,

Radiator hose, 34,

Water pump, 36,

Radiator, 38.

FIG. 1 is a generic prior art diesel engine having a fuel tank 10, a fuel line 14 to the fuel filter 30, a fuel pump 29, fuel line 14a from the filter 30 to the fuel pump 29, fuel line 14b from the fuel pump 29 to an injector pump 28, fuel return lines 12, 12a and 12b, fuel lines to the injectors 26, injectors 24, the engine 22, a heater core 16, a heater hose 18, a heater hose 20, a water pump 36, a radiator hose 34, a radiator 40, and radiator hose 32. It is unnecessary to describe the operation of a normal diesel engine running on diesel fuel.

FIGS. 2 and 3 show one prior art design for a heater 40 to be installed near the injector pump in which a heating coil 42 has concentric tubing to provide an inner line 44 for engine coolant and an outer line 46 for fuel. The inner line 44 is attached by fittings 48 to the incoming and exiting coolant lines 50 and 52 respectively and the outer line 46 is attached by fittings 54 and 56 to incoming and outgoing fuel lines 58 and 60 respectively. In operation as fuel flows through the outer line 46 it is heated by engine coolant flowing through the inner line 44. It is recognized that this rather bulky part requires attachment to the coolant system and mounting parts. This requires that fuel lines be rerouted. Since automobiles are designed differently mounting parts vary with the vehicle design. As is common with prior art conversions a heater of this kind must be mounted with customized mounting gear in order to be close to the injector pump and requires rerouting of the fuel lines.

There is a need for a more economical and easier to install means for heating fuel in a diesel engine conversion. There is also a need for a better way to filter the fuel.

### SUMMARY OF THE INVENTION

The invention resides most generally in apparatus and methods that condition the alternative fuel for use in a diesel engine.

In one aspect, the invention resides in eliminating the stock filter and substituting in its place using the stock filter mount, a heat exchanger with a fuel heating chamber for fuel to be passed through which chamber is exposed to a heat source so that the fuel that passes through the fuel heating chamber is heated and then flows to the injector pump. This takes advantage of the fact that the stock filter and filter mount are in a place quite close to the engine so that the heating is done close to the engine and eliminates the need for awkward mounting of a fuel heater. It saves a great deal of extra routing of the fuel lines, and providing mounting elements for an auxiliary heater. A substitute filter is employed which in any event is needed to satisfy the filtering needs for the alternative fuels.

In another aspect the invention resides in a heat exchanger and impurities filter that will allow impurities to be filtered in a transparent shell so that the level of exhaustion of its life cycle can be observed. Also, it has a feature that allows accumulated sludge to be drained. This aspect of the invention can be used alone or in combination with the first described aspect above.

### BRIEF DESCRIPTION OF THE DRAWINGS

FIG. 1 is a generic schematic view of a standard diesel engine of the prior art.

FIG. 2 is a prior art fuel heater.

FIG. 3 is detail of the fuel heater of FIG. 2.

FIG. 4 is a generic schematic view of a converted diesel engine system in which the present invention is implemented.

FIG. 5 is a perspective view of an embodiment of the present invention.

FIG. 6 is an exploded view of the embodiment of FIG. 5.

FIG. 7 is a section view through A-A of FIG. 4.

FIG. 8 is alternative embodiment of the invention.

FIG. 9 is another alternative embodiment of the invention.

FIG. 10 is prospective view of the fuel heating chamber of the invention.

### DETAILED DESCRIPTION

The invention resides in steps and devices for conditioning alternative fuels for use in diesel engines. In one embodiment the invention is provided as a kit that can be installed in a diesel engine equipped vehicle. A feature of the present invention resides in treating the alternative fuel to run on an engine that has no, or very little need for converting engine components such as injectors.

The invention avoids the problem of rerouting fuel lines to bypass the stock filter mount, and it eliminates the problem of finding a way to mount a heater near the injector pump and performing the heating near the injector pump and the problem of rerouting fuel lines to connect to a heater.

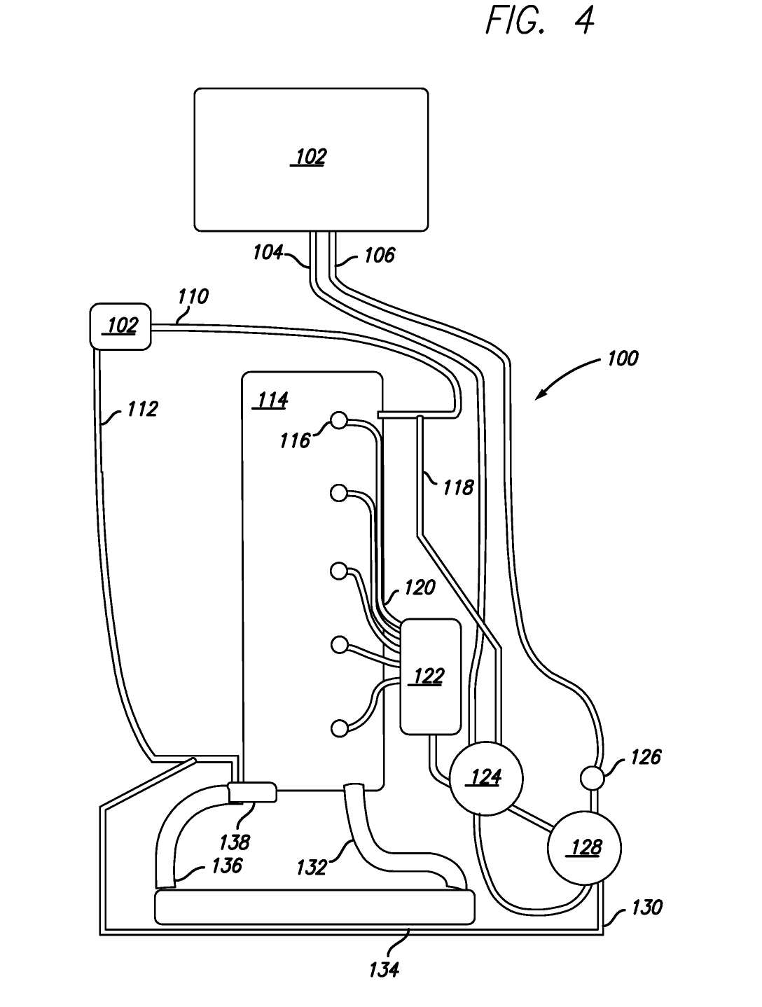

FIG. 4 is a generic schematic diagram of a converted diesel engine system 100 in which the present invention is implemented. The parts are;

Fuel tank, 102,

Fuel return line, 104,

Fuel line to engine, 106,

Heater core, 108,

Heater hose, 110,

Heater hose, 112,

Engine, 114,

Fuel Injectors (5), 116,

Heater hose to/from exchanger, 118,

Fuel lines to injectors, 120,

Injector pump, 122,

Heat exchanger, 124,

Electric fuel pump, 126,

Filter assembly, 128,

Heater hose to filter assembly, 130,

Radiator hose, 132,

Radiator, 134,

Radiator hose, 136,

Water pump, 138.

The fact that the present invention allows the use of the stock filter mount and avoids any rerouting of fuel lines or mounting of a fuel heater is an important part of the method of the present invention as will be seen, because it renders simplicity and low cost to the conversion; it massively simplifies the conversion process and system.

The conversion method comprises substituting for the stock filter a heater so that the fuel will flow through the heater to the injector pump. Such a heater is described below.

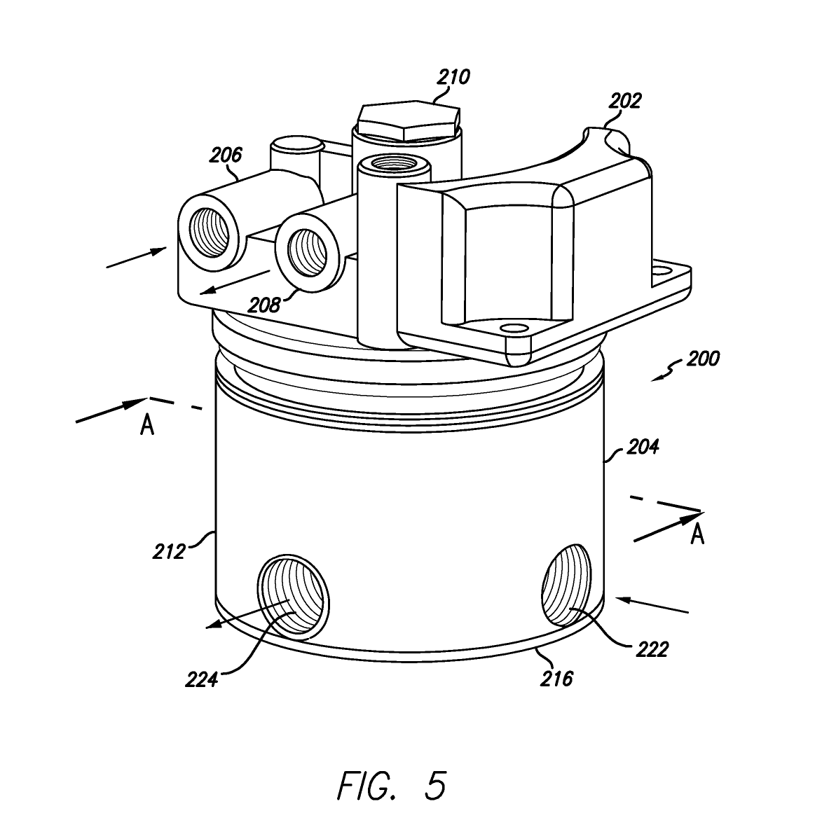

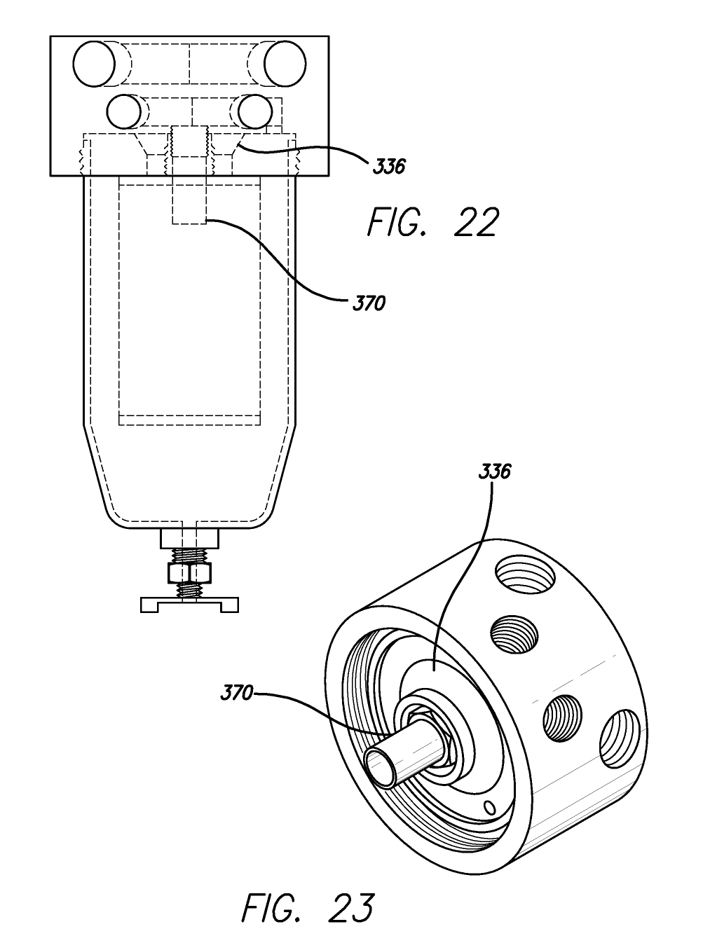

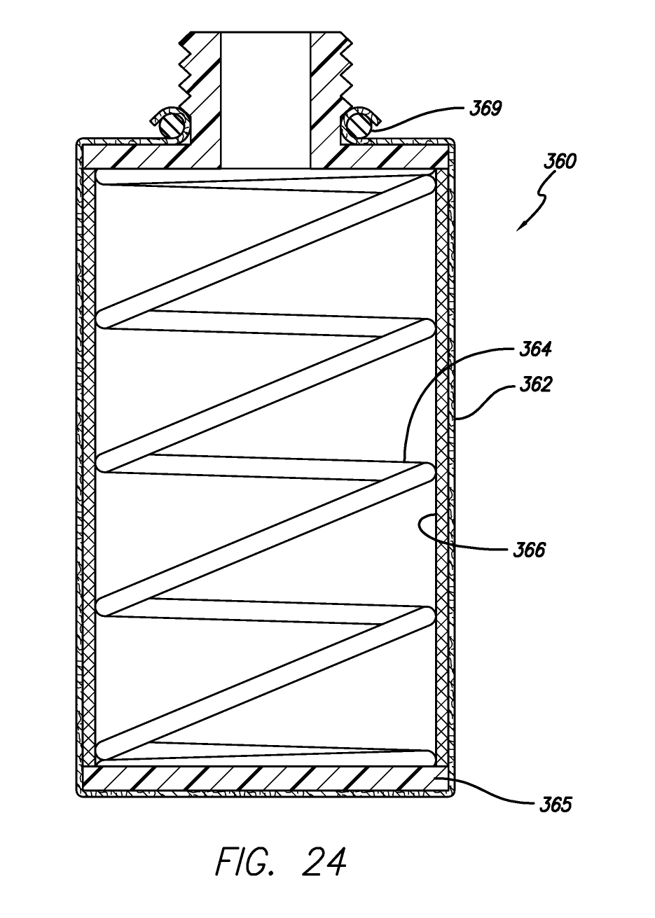

Referring now to FIGS. 5, 6, 7 and 10 an embodiment of the heat exchanger (seen as 124 in FIG. 4) of the invention is described. In this embodiment engine coolant is used as the heat source. The apparatus 200 uses the stock filter mount 202 on which the heat exchanger 204 is mounted. The stock filter mount 202 has fuel-in and fuel-out ports at 206 and 208 respectively. When in use as stock, a stock fuel filter is attached below the stock filter mount, attached in the well known manner by way of the hollow bolt 210 which also serves as part of the fuel-out porting. The hollow bolt 210 is also used in the present invention, and it performs the same function as it did originally to retain the stock filter, in this case to retain the heat exchanger and for fuel-out porting . . . .

The heat exchanger 204 has a heat exchanger body 212 having a fuel heating chamber 214 and a heat transfer portion 216. A high heat transfer rate surface 218 is between the fuel heating chamber 214 and the heat transfer portion 216 so as to rapidly transfer heat to the fuel in the heat transfer chamber 214 from the heat transfer portion 216. The heat transfer surface 218 is configured with concentric ridges 220 to have increased surface area inside the heat transfer chamber 216, so as cause rapid heat transfer. The heat transfer portion 216 has a coolant-in port 222 and a coolant-out port 224, receiving coolant from a coolant-in line 226 and delivering it to a coolant-out line 228, the latter being diverted from and sent back to the coolant system. The heat exchanger body 212 is preferably made from a single piece, machined to the configuration shown, and preferably of a high heat exchange rate material such as aluminum, in order to allow a high heat exchange rate through the heat transfer surface 218. It could be surrounded by an insulating material if desired.

In order to mount the heat exchanger 204 to the stock filter mount 202 an adapter element is provided that will be attached to or made integrally as a part of the heat exchanger body and that is configured to have passages that will allow fuel from the stock filter mount fuel-in port 206 to flow into the fuel heating chamber 214, and will allow heated fuel to flow from the fuel heating chamber 214 into the fuel-out port 208. The adapter element will be able to mount on the stock filter mount 202 in a manner at least analogous to the way a stock filter mounts so as to facilitate flow of fuel into and out of the fuel heating chamber 214.

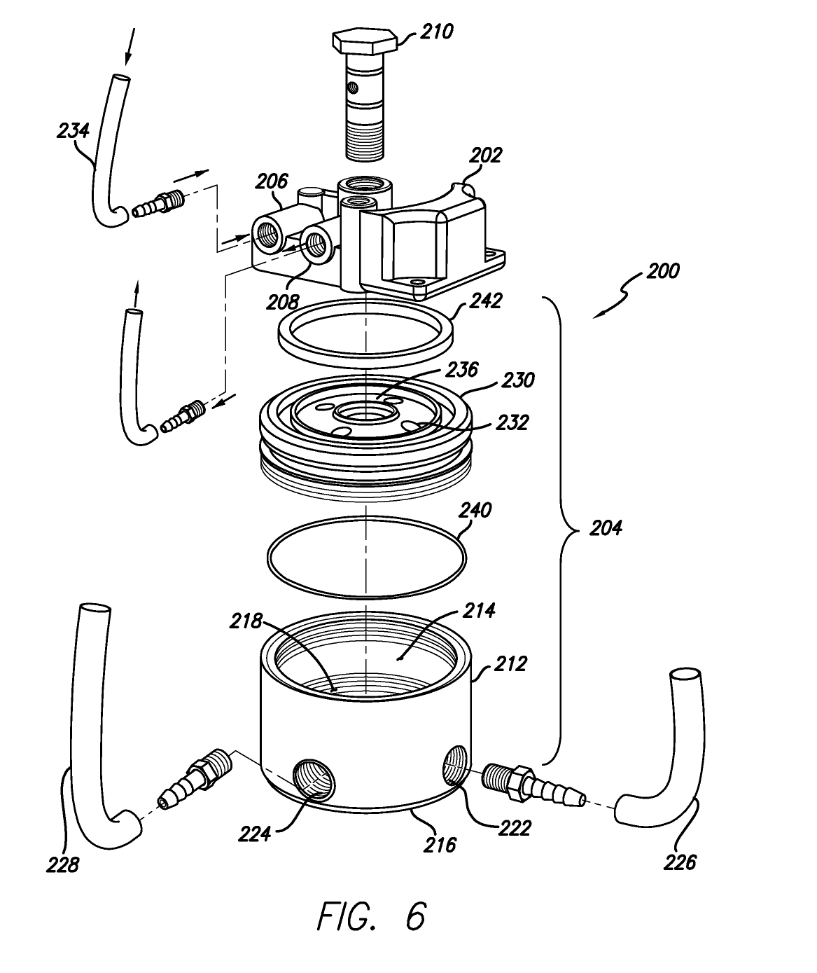

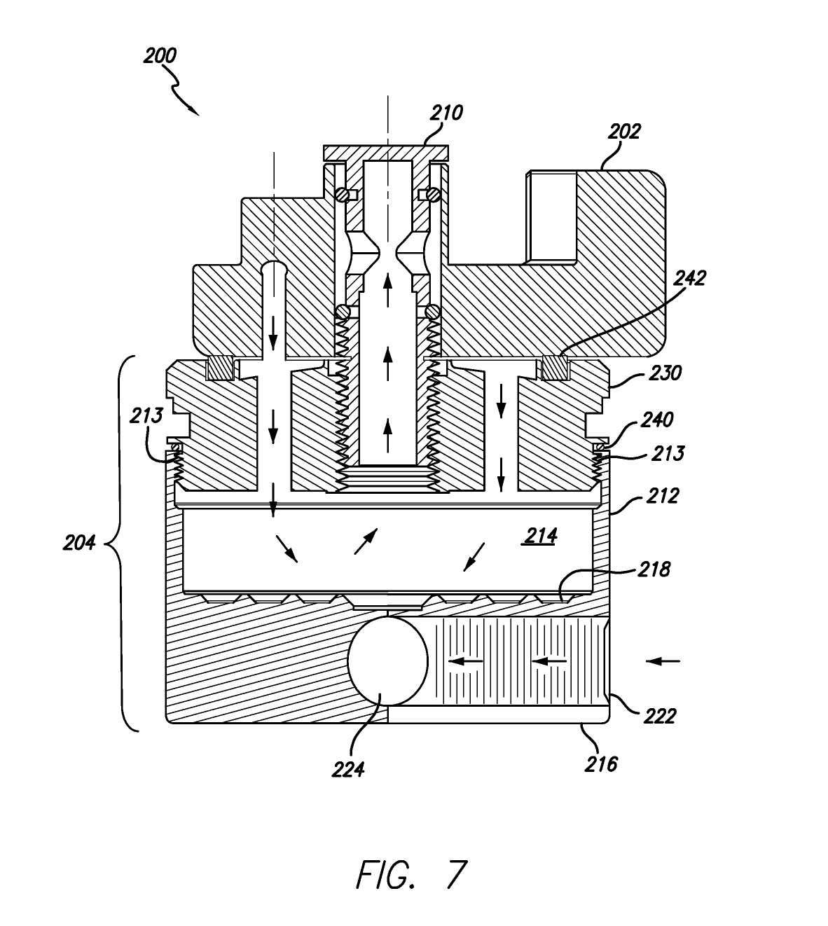

Referring to FIGS. 6 and 7, a preferred adapter element is an adapter plate 230 that is fixed to the top of the heat exchanger body 212, as shown by threads, although any convenient means of mounting it to the heat exchanger body 212 can be used. The adapter plate 230 mimics the top of a stock filter so as to provide fuel-in passages 232 in communication with the fuel-in port 206 which receives fuel from a stock fuel-in line 234. The fuel flow is shown by arrows. The adapter plate 230 has a threaded central hole 236 to engage the threaded hollow bolt 210 by means of which the assembly is fitted in place in the same manner as the stock filter which it replaces. Fuel in the fuel heating chamber 214 exits through the hollow bolt 210 to the fuel-out port 208 and is then directed into the engine via a stock fuel-out line 238.

An O-ring 240 seals the adapter plate 230 when threaded to the heat exchanger body 212 by threads 213 and an O-ring or sealing washer 242 seals the heat exchanger body 204 to the stock filter mount 202.

In use as part of a conversion kit installation, the heat exchanger 204 is installed on the stock filter mount 202, with coolant-in line 226 and coolant-out line 228 fitted as shown. The fuel-in and fuel-out lines remain as stock installations.

In operation, hot coolant flowing into and out of the heat transfer portion 216 will transfer heat into the heat transfer portion 216 which will transfer into the fuel passing through the fuel heating chamber 214.

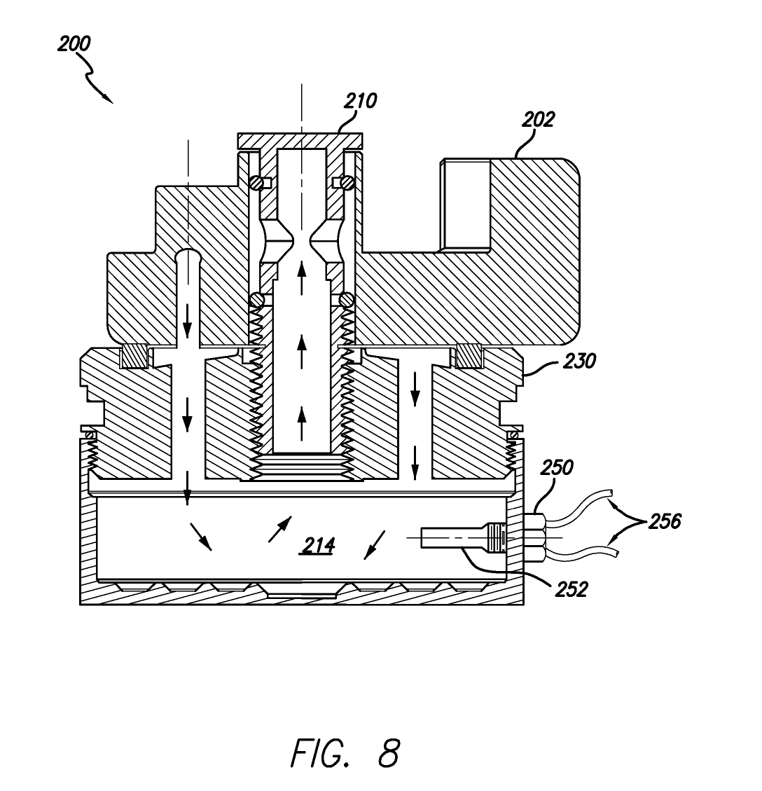

An alternative embodiment is shown in FIG. 8 which uses an electrical heat source. In this embodiment a heat element 250 in the form of a transducer is mounted in the wall of the fuel heating chamber 214, its heating rod 252 being in the fuel and with wiring 256 to the source of electricity from the battery and the alternator.

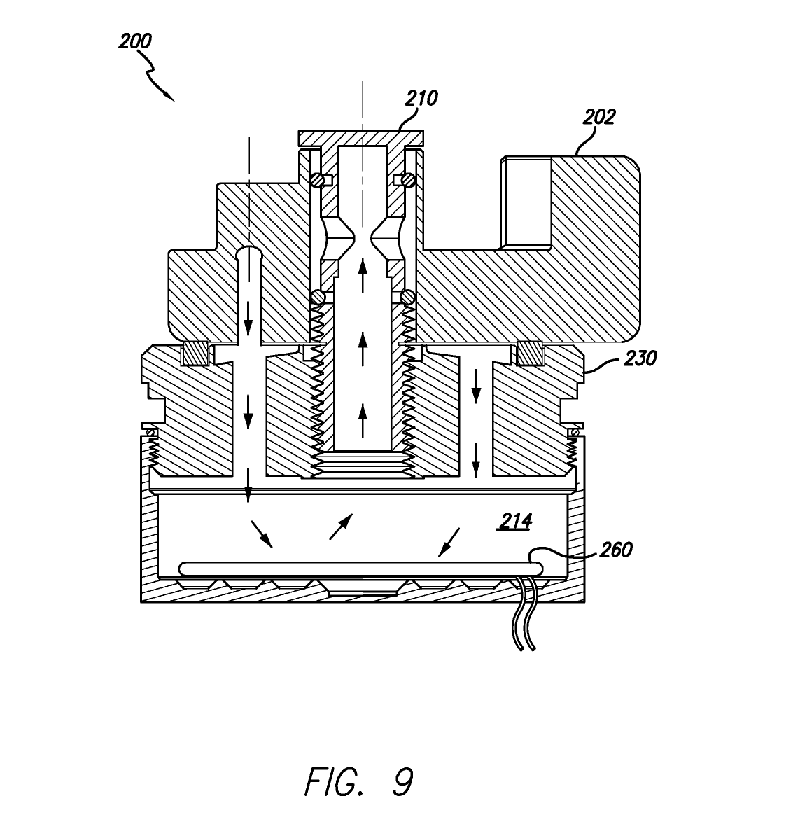

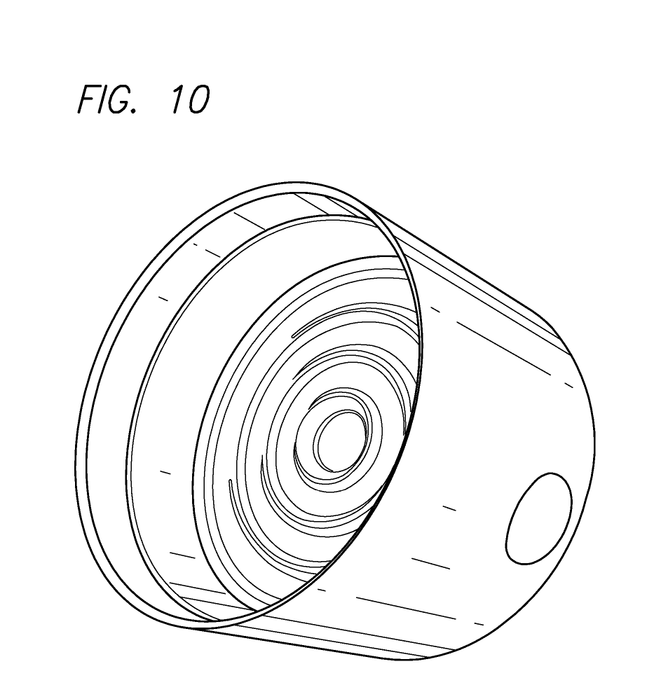

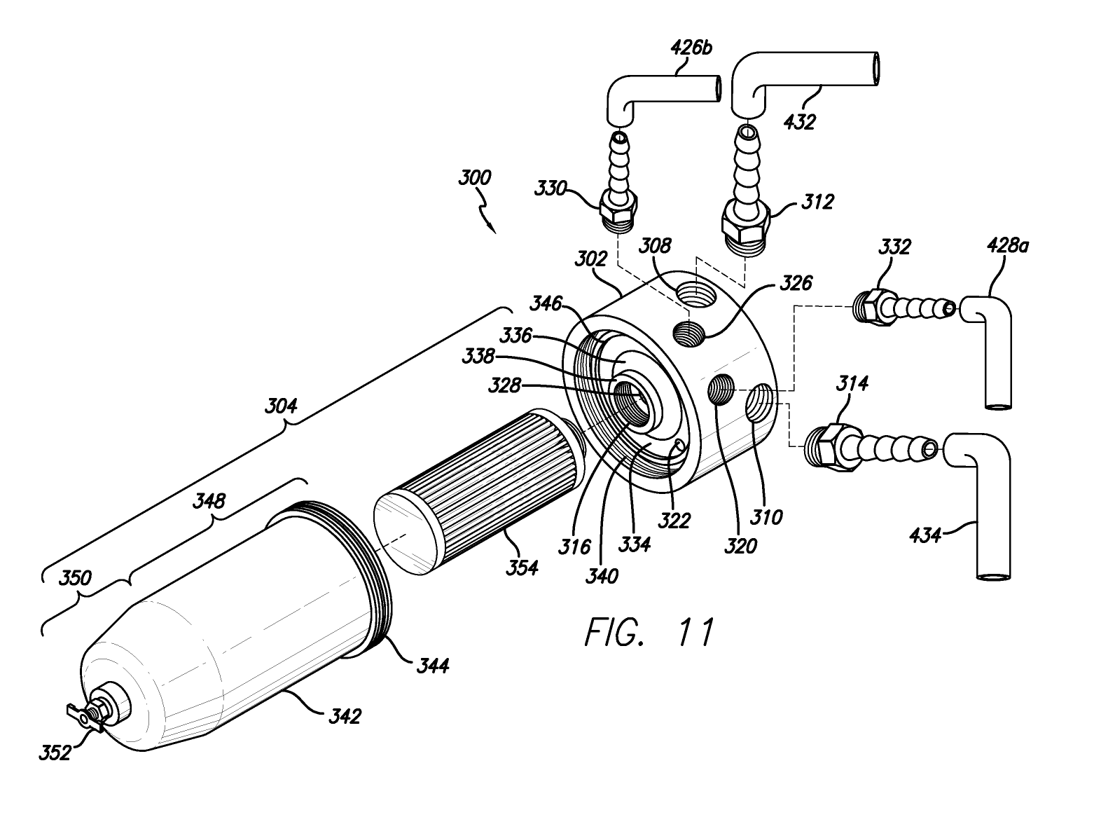

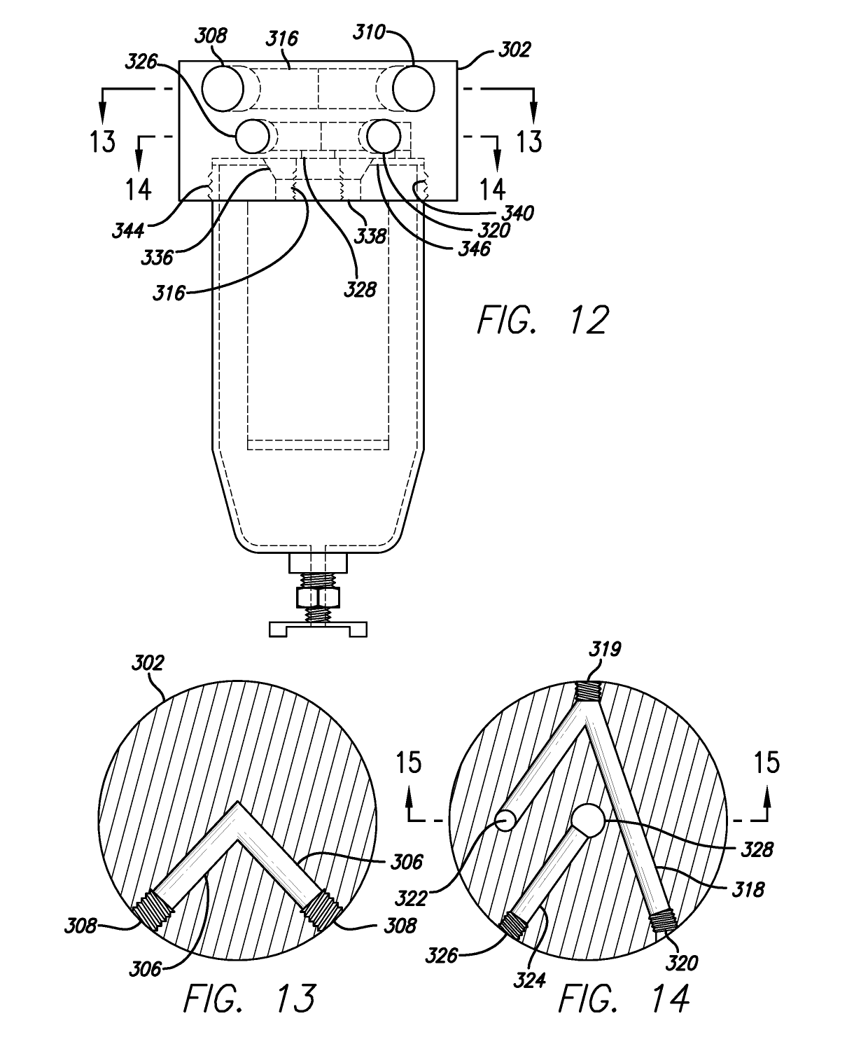

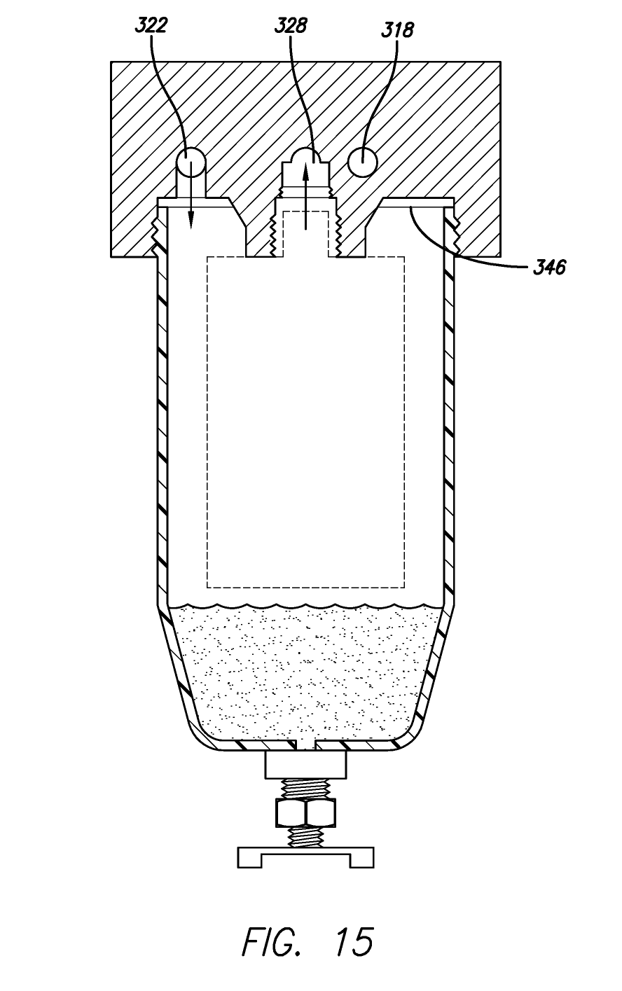

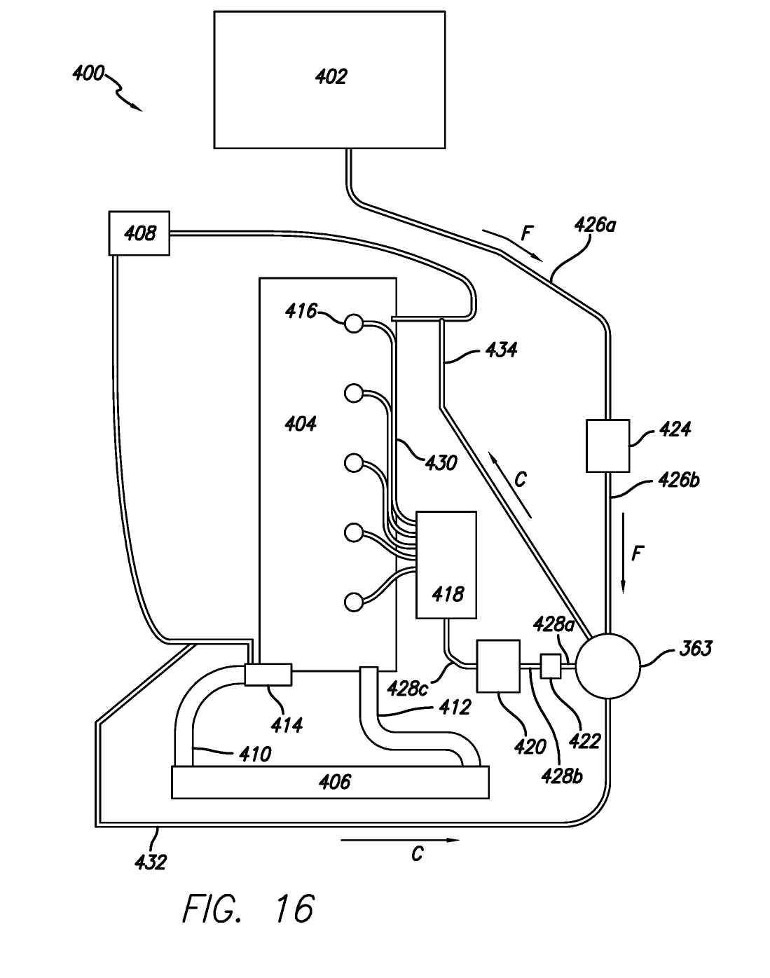

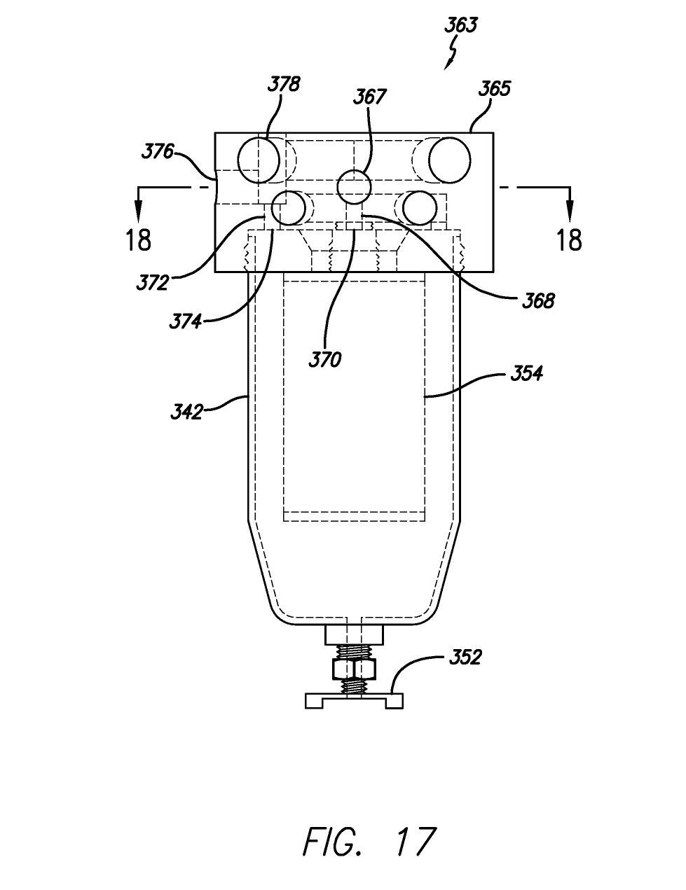

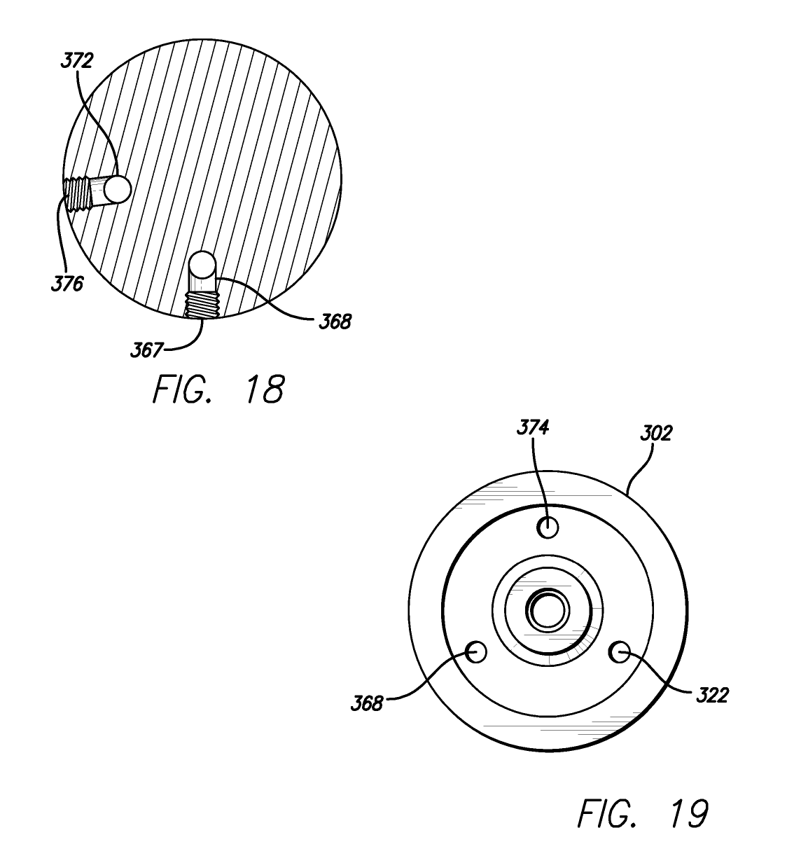

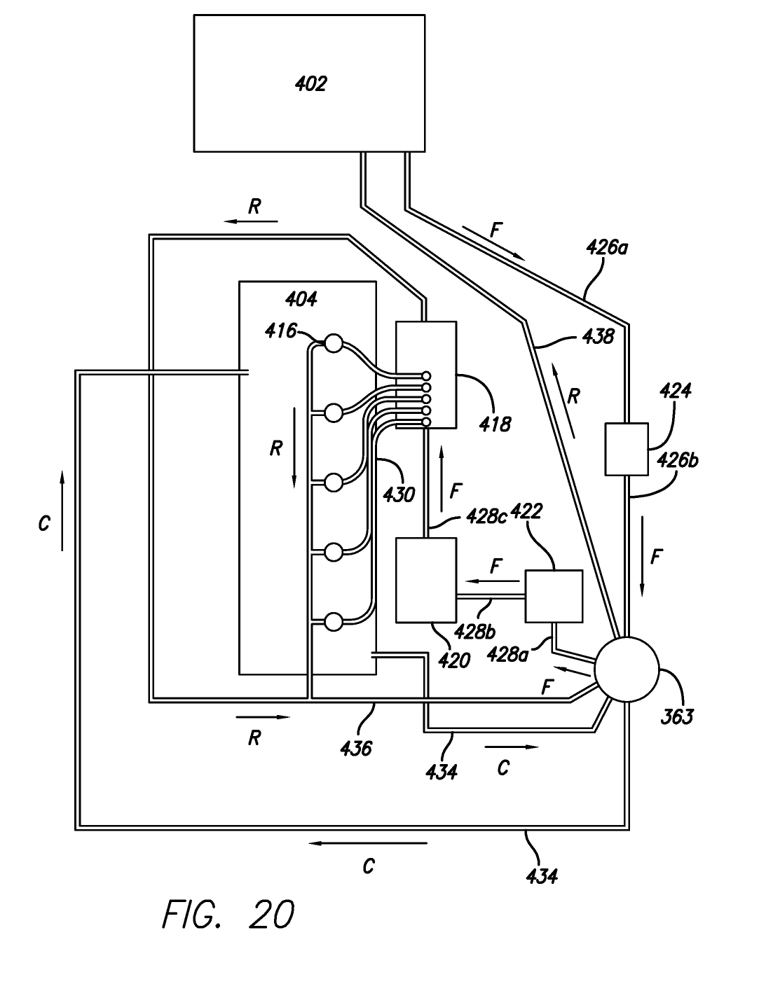

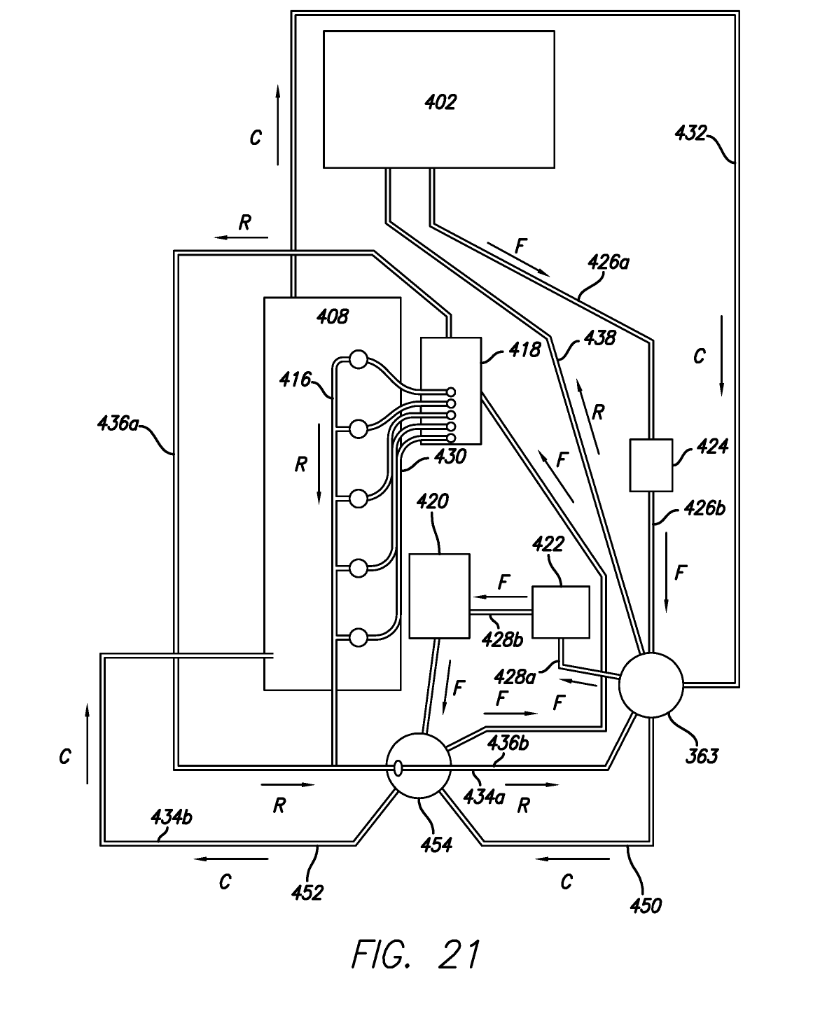

In a further embodiment as shown in FIG. 9, a coil heater 260 is fitted at the bottom of the fuel heating chamber 214 having electrical heating coils that are connected to a source of electricity.

Further aspects of apparatus, systems and methods for conditioning fuel for converting diesel engines to operate with alternative fuels is described with reference to FIGS. 11-24.

In one embodiment, a combined heat exchanger and impurities filter assembly are installed in the fuel line (also referred to as a combined heat exchanger and filter.

The methods of installation vary based on the stock set up for the vehicle. For example, in Mercedes Benz cars, the stock filter mount has several functions that are useful to retain, so keeping the stock filter mount is useful. In other cars different accommodations are needed. Typically installation would be done as a substitute for the stock filter which would be removed or bypassed. Alternatively, the above described fuel heating device 200 can be substituted for the stock filter and the combined heat exchanger and impurities filter used. These and other forms and combinations will be described below although they are not exhaustive of installations since cars vary. In still other aspects the invention provides an improved means for routing and using return fuel and for removing air from the fuel system.

Now referring to FIGS. 11-17 one embodiment of a combined heat exchanger and filter 300 is shown. In this embodiment the combined fuel heater and filter has a heat exchanger body 302 and a filter assembly 304.

The heat exchanger body 302 is made of a high heat exchange coefficient material such as aluminum. It has ports and flow passages for coolant from the engine cooling system and for fuel from the fuel tank.

Although reference is made to coolant, it is understood that the coolant is a source of heat. A coolant passage 306 extends between a first coolant port 308 and a second coolant port 310, both of which are threaded to accept first and second coolant fittings 312 and 314. The coolant passage 306 is beneficially extended in an elongated path through the heat exchanger body 302, such as the “V” shape shown, so that it will have the effect of a large and distributed surface area for heat transfer from coolant flowing through it in order to cause the heat exchanger body 302 to heat up sufficiently.

The heat exchanger body 302 has a fuel input passage 318 extending from a threaded fuel input port 320 to a filter input port 322 which is located at the bottom of the heat exchanger body 302 to cause fuel to flow into the filter space as will be described below. There is also a fuel output passage 324 extending from a fuel output port 326 to a filter output port 328 in the bottom of the heat exchanger body 302. The fuel input port and fuel output port 320 and 326 are threaded to accept fuel input fitting 330 and fuel output fitting 332, respectively. The passage 318 is made from drilled holes with a plug 319.

The heat exchanger body 302 has a bottom portion generally labeled 334 with an internally threaded boss 336 located in its center which is open to the filter output port 328 at its center and has a sealing surface 338 and internal threads 316. The bottom portion 334 also has peripheral internal threads 340. The filter input port 322 is at the bottom portion 334 radially away from the center.

Attached below the heat exchanger body 302 is the filter assembly 304. The filter assembly 304 has a shell 342, preferably transparent or at least translucent, which is removably attached by threads 344 to the peripheral internal threads 340 of the heat exchanger body 302. A ring seal 346 is seated for sealing attachment of the shell 342 to the heat exchanger body 302. The shell 342 is considered as defining a filter space having an upper portion 348 and a lower portion 350. At the bottom of the shell 342 there is a drain valve 352.

A fuel filter element 354 resides in the upper portion 348 of the filter space, being screwed onto the threaded boss 336, and sealed on the sealing surface 338. The fuel filter element 354 can be a selected commercial filter such as which typically use paper for the filtering member. The paper filter should be in the range of 20-10 microns. However, as will be described below, a different filter construction is preferred.

In use, the combined 1 heater exchanger and filter 300 is installed in a diesel engine system as part of a conversion to run on alternative fuels. It is mounted in a convenient place in an upright orientation. As is apparent, it should be mounted in an orientation to the extent possible that the filter is vertically under the heat exchanger as will be understood by the explanation to follow. Some tilt from a strict vertical arrangement can be tolerated, and is necessary in some installations, however the limit of tilt that can be tolerated and the amount of degradation of operation will be appreciated by those skilled in the art, based on the explanation of operation given below. In general it will be appreciated that engine coolant runs through the heat exchanger body 302 and transfers heat into the heat exchanger body 302. Fuel run through the heat exchanger body 302 is heated as it passes through the heat exchanger body. The fuel passes through the heat exchanger body 302 twice. The first time is when it comes from the fuel tank through the fuel input passage and into the filter assembly outside the filter element. The second time is when it exits the filter assembly from inside the filter element and runs through the fuel output passage. From there it goes to the engine. The fuel is filtered in the filter assembly as it passes into the filter element and sludge collects in the bottom of the filter assembly from which it can be removed by opening the drain valve. Particles collect on the outside of the filter barrier portion of the filter element. The filter assembly shell is transparent or translucent so that the condition inside can be observed, especially the build up of sludge at the bottom and also the condition of the filter barrier portion.

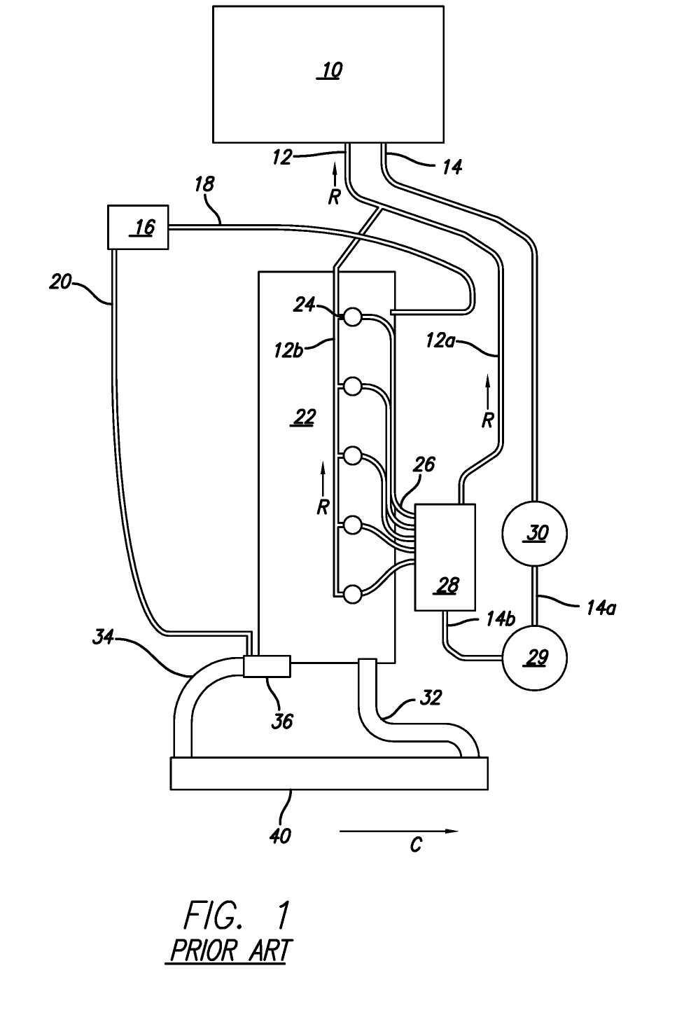

Application of the combined heat exchanger and filter 300 into an engine system will now be explained with reference to FIG. 16 in which the exemplary engine system 400 has a fuel tank 402, an engine 404, a radiator 406, a heater core 408, radiator hoses 410 and 412, a water pump 414, fuel injectors 416, an injector pump 418, a fuel pump 420, a fuel filter 422, an auxiliary fuel pump 424, a combined heat exchanger and fuel filter 300. A fuel line 426a and 426b provides fuel from the fuel tank 402 through the auxiliary pump 424 to the combined heat exchanger and fuel filter 300. A fuel line 428a, 428b and 428c runs fuel from the combine heat exchanger and fuel filter 300 through a secondary fuel filter 422 (this is preferably a plastic transparent fuel filter to enable viewing the condition of the fuel supply for air or debris) and the fuel pump 420 to the injector pump 418. Fuel lines 430 run from the injector pump 418 to the injectors 416. Engine coolant runs from the water pump 414 through a coolant input line 432 to the combined heat exchanger and fuel filter 300, and then back into the coolant system via a coolant exit line 434. This system would normally have a fuel return line such as shown in FIG. 1.

In the exemplary system, and with reference to FIGS. 11-16 coolant from the engine cooling system is introduced from the coolant input line 432, connected to the coolant input fitting 312 screwed into the coolant input port 308. Coolant leaving the heat exchanger body 302 exits the threaded coolant output port 310 that has screwed into it a coolant output fitting 314 and then through a coolant output hose 434 back into the engine cooling system. Inside the heat exchanger body 302 the coolant flows through the line (also called passages) 306 which is in this example, in the form of intersecting drilled holes. It is important that the coolant flow through the greatest solid volume and over the longest line inside the exchanger body 302 that is practical in order to result in the greatest heat transfer into the heat exchanger body.

Again referring to FIGS. 11-16, the fuel is introduced from the fuel input line 426b, connected to the fuel input fitting 330 screwed into the threaded fuel input port 318. Fuel exiting the heat exchanger body 302 exits the threaded fuel output port 326 that has screwed into it the fuel output fitting 330. Inside the heat exchanger body 302 the incoming fuel flows through the fuel input line 318 defined by intersecting drilled holes. Notably the fuel input line 318 runs the incoming fuel through a substantial distance in the heat exchanger body 302 which allows a sufficient amount of heating of the fuel by transfer of heat from the heat exchanger body 302, which heat is acquired from the coolant running through it as described above. The fuel input line 318 ends at the fuel filter input port 322 at the bottom portion 334 of the heat exchanger body 302. The bottom portion 334, in addition to having the fuel filter input port 322, has the fuel filter output port 328 and surrounding it the filter mounting boss 340 which has internal threads 342 and the filter sealing surface 344. After passing through the filter 354, the fuel will exit the filter assembly via the fuel filter output port 328 and once again pass through the heat exchanger 302 in the line 324 where it passes onto the fuel line 428a

During operation of the engine the fuel will flow through the combined heat exchanger and fuel filter as described above. Typically, the shell 342 will fill with fuel. Fuel in the shell will pass through the filter 354. Impurities and debris, including water, will be filtered out and will either stay on the outside of the filtering surface, or will drop to the bottom as sludge. The filtered fuel will then be used to run the engine. Impurities that drop to the bottom of the shell 342 will collect there until drained out by operating the drain valve 352.

A convenient mounting structure can be fabricated for mounting the combined heat exchanger and filter, which can be fashioned by those skilled in the art. It is important that it be mounted as close to upright as possible and with visual access to observe the condition of the filter element and the collection of sludge, and with access to open and drain the sludge and to remove the shell 342 so as to access and change the filter element and clean the sludge chamber. Instead of the valve 352, a drain tube terminated with a valve can be fitted leading to a more convenient draining location.

FIG. 24 shows an alternative fuel filter element 360. This element is made of a cloth filter member 362 with an interior support structure shown as a spiral of wire 364, to keep the cloth filter member 362, open. A wire mesh 366 surrounds the interior support structure, inside the cloth filter member 362 and serves to support the cloth filter member 362. The cloth filter is conveniently made in the form of a bag and attached to the supporting structure by an O-ring 368 that is fitted around the upper end 369 of the filter. The cloth filter member should have a specification to prevent particles larger than 2 microns from passing through it. The wire mesh may be omitted; it is not intended to operate as a filter element, and it should be open enough to allow the now filtered fuel to easily pass into the interior of the filter element 360 without creating backpressure.

While the foregoing describes the basic attributes of the combined fuel heater and filter, there is yet another alternative structure of the invention as shown in FIGS. 17-20. In this aspect, in addition to the structure of the combined heat exchanger and fuel filter described above, return fuel is beneficially routed through it. By routing the return fuel through it, the return fuel is again heated and becomes part of the fuel supply flowing into the filter space along with new fuel from the tank. Therefore, this avoids putting all of the return fuel back in the fuel tank, instead cycling it again without losing its heat, through the combined heat exchanger and filter so as to generally upgrade the overall condition of the fuel presented to the filter and consequently for use in the engine. It is assumed that some of the fuel will return to the fuel tank, and as this is a mixture of filtered and unfiltered fuel, it upgrades the overall quality of the fuel in the tank. Also, having been heated again and mixed with heated fuel, the fuel in the tank is now at a higher temperature which makes pumping it back to the engine easier and generally less contaminated. Notably the return fuel has been also subjected to increased heat as it passed through the injector pump and bypassed across the injectors. The returning fuel can also serve to increase the heat contained in the heat exchanger, giving it a higher average temperature.

In particular, referring to FIGS. 17, 18, 19 and 20 there is shown a combination heat exchanger and filter 363 having a heat exchanger body 365 which have all of the structure described above. There is in addition to the elements described above, a return fuel input port 367 and a return fuel line 368 which opens to the filter space in the shell 342 at the bottom portion 334 through a return fuel filter input port 370, which is exterior to the filter element 354. Also a return fuel exit line 372 extends from a return fuel filter exit port 374, also exterior to the filter element 354 to either of optional return fuel heat exchanger exit ports 376, or 378.

The system using the combined heat exchanger and filter that uses return fuel is shown in FIG. 20. In this figure the detail of the cooling system are omitted as it is unnecessary to repeat them, but otherwise replicates FIG. 16 for the common parts. The operation is the same as explained above except for the imposition of return fuel through the heat exchanger 365. Return fuel comes from the injector pump 418 via line 436 and upon exiting the heat exchanger 363 goes back to the fuel tank 402 via line 438. It is noted that the fuel returned through line 436 passes through the heat exchanger and goes into the filter, where it mixes with fuel drawn from the tank. That mixture is filtered and sent to the engine. Also, when there is still excess fuel in the filter chamber, it will exit passing again through the heat exchanger, but as a mixture, and will return to the tank. Also, return fuel may have air entrained in it. The air will collect at the top of the filter chamber and will be carried back to the fuel tank. The technology relating to the cause and amount of return fuel in a diesel engine is well known, it is sufficient to observe that there is more return fuel at higher RPM.

In another aspect of the invention, with reference to FIGS. 22 and 23 an extension tube 380 is screwed into internal threads 382 in the boss, and has a threaded portion 384 for mounting of the filter 354. The extension tube extends downwardly inside filter 354. The extension tube 382 is particularly but not exclusively useful in the version in which return fuel is fed into the filter shell 342 because this may create air bubbles that will be at the top and that can pass through the filter 354. With the extension tube 380 in place, fuel is drawn only from the bottom of the extension tube

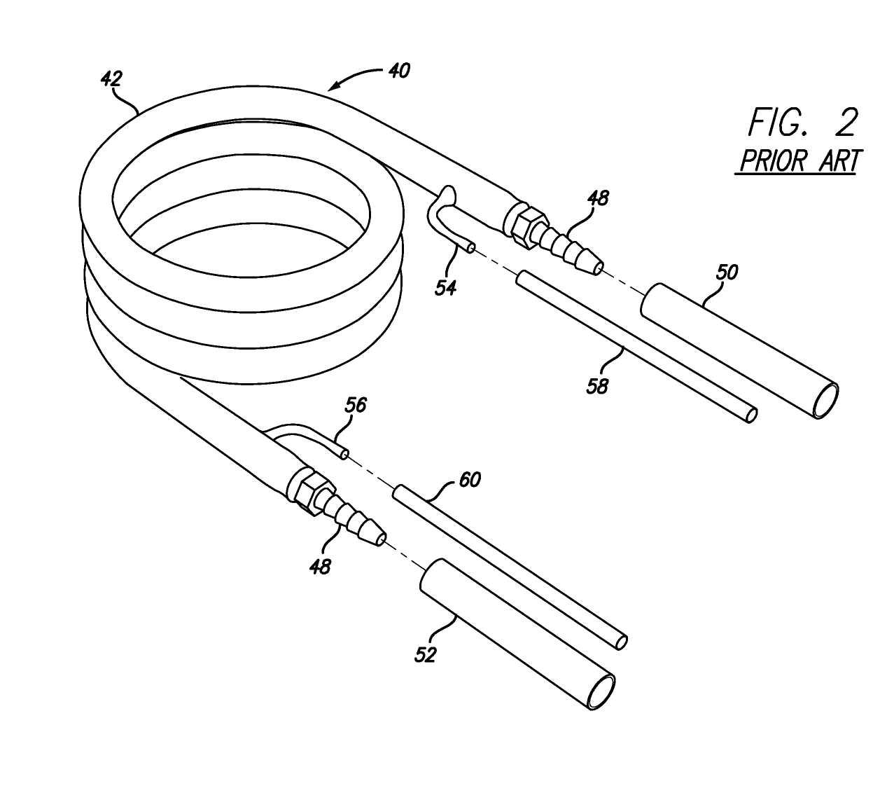

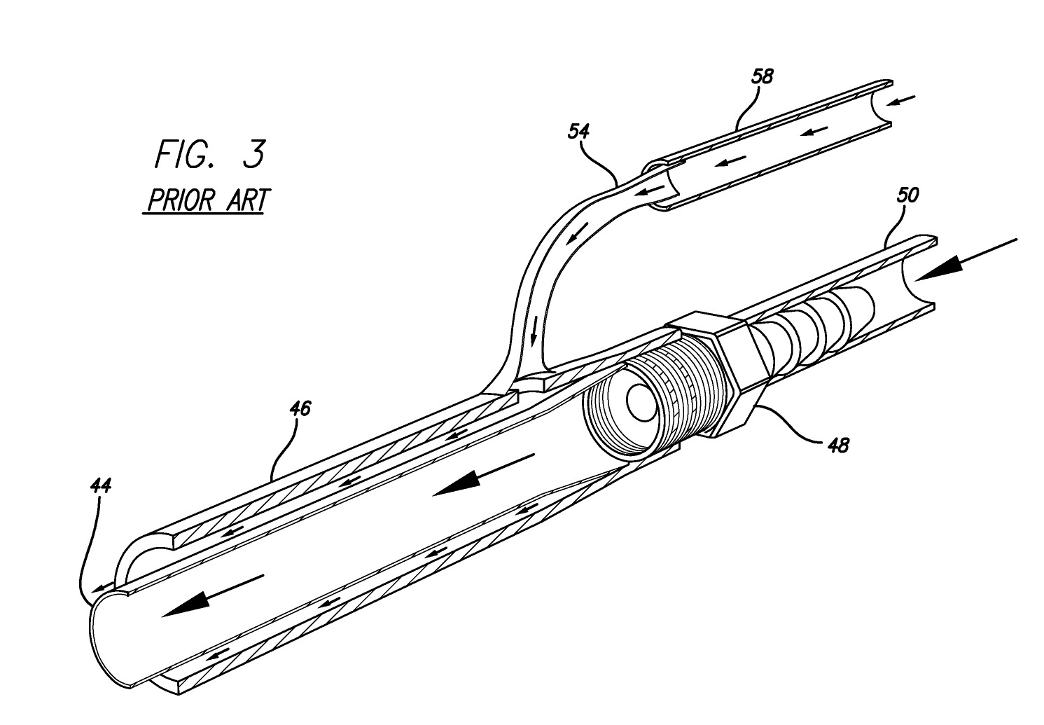

A further aspect of the invention will now be described with reference to FIG. 21. In this version, the invention is employed using the stock filter mount and heat exchanger as described above in combination with the combined heat exchanger and filter. This is a common conversion for a Mercedes diesel, and other makes that have a stock filter mount available for conversion. This can be seen in FIG. 21 in which a number of changes are apparent in order to make the combination. One change relates to the flow of fuel. Fuel exiting the combined heat exchanger and filter 363, flows as described above through the secondary fuel filter 422 and the fuel pump 420, then into the secondary heat exchanger 454 which is described above with reference to FIGS. 1-19 and numbered as 200. The fuel then flows to the injector pump 418. Coolant flows through the combined heat exchanger and filter 363 as described above, then exiting the combined heat exchanger and filter 363 and into the secondary heat exchanger 454. The coolant exits the secondary heat exchanger and returns to the coolant system. Return fuel flows according to the stock set up via the stock filter mount (through a banjo valve mounted on it) and then is routed to the combined heat exchanger and filter 363.

FIGS. 22 and 23 show an alternative configuration in which a nipple 370 is attached inside the boss 336 as a continuation of the filter fuel output port 328 (see FIGS. 11-14). The nipple is a precaution against air that may accumulate at the top of the filter space from entering the stream of fuel heading for use in the engine.

The method of the invention in an exemplary case can be implemented with the apparatus described above, following the steps of providing the parts so as to accomplish the operations described. The parts can be provided as a kit for installation.

Although the best mode contemplated by the inventor of carrying out the present invention is disclosed above, practice of the present invention is not limited thereto. It will be apparent that various additions, modifications and rearrangements of the features of the present invention may be made without deviating from the spirit and scope of the underlying inventive concept.

Moreover, the individual components need not be formed only in the disclosed shapes, or assembled only in the disclosed configuration, but could be provided in any shape or configuration which operate together so as to provide the heating of fuel in an assembly that is attached to the stock filter mount.

The foregoing Detailed Description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. This disclosure has been made with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the Claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “step(s) for . . . ”

1. An apparatus for conditioning alternative fuel in a conversion for operating a diesel engine on alternative fuel comprising;
a heat exchanger having a passage for the flow of engine coolant into and out of the heat exchanger and having a fuel input path and a fuel output path;
a filter assembly mounted proximate the fuel heating chamber said filter assembly comprising;
a shell defining a filter space therein the filter space having an upper portion and a lower portion;
a filter mounted in the filter space at the upper portion thereof;
a collection space at the lower portion of the filter space;
the filter assembly having fuel flow communication with the fuel input passage in the heat exchanger to the filter space exteriorly of the filter and having fuel flow communication with the fuel output passage of the heat exchanger from inside the filter;
whereby engine coolant flowing through it heat the heat exchanger which operates to heat fuel flowing into and out of it and incoming fuel passes from the heat exchanger into the filter space exteriorly of the filter and then passes through the filter and back into the heat exchanger form the interior of the filter and exits the heat exchanger whereby impurities are filtered form flowing through the filter so that fuel passing to the fuel output line is purified an heated and the impurities collect in the collection space of the lower portion.

2. The apparatus of claim 1 further comprising a means at a bottom of the lower portion of the filter whereby impurities that have fallen to the collection space can be drained off.

3. The apparatus of claim 1 further comprising a fuel pump upstream of the heat exchange, in a fuel line connected to the fuel input passage in the heat exchanger.

4. The apparatus of claim 1 wherein the filter comprises a woven fabric portion and a support structure inside the woven fabric portion for maintaining it in an open configuration.

5. The apparatus of claim 1 wherein the filter assembly is removably attached to and below the heat exchanger.

6. The apparatus of claim 1 wherein the filter shell is either transparent or sufficiently translucent that the level of the collection of impurities can be observed.

7. The apparatus of claim 1 further comprising a return fuel input line extending from a return fuel input port, through the heat exchanger body and into return fuel flow communication with the filter assembly exteriorly of the filter element and a return fuel output line extending from a filter return fuel output port, through the heat exchanger body to a return fuel output port.

8. The apparatus of claim 1 for application in an engine system having a stock filter mount further comprising;
a second heat exchanger for heating fuel comprising;
a fuel heating chamber;
an adapter element on the fuel heating chamber and being mountable to the stock filter mount, said adapter element having at least one passage for allowing incoming fuel from a stock filter mount fuel-in port to flow into the fuel heating chamber and having at least one passage for allowing outgoing fuel from the fuel heating chamber to flow into a stock filter mount fuel-out port;
a heat transfer portion in close proximity to the fuel heating chamber;
a source of heat into the heat transfer portion;
whereby heat from the heat transfer portion will heat the fuel flowing through the fuel heating chamber and fuel exiting the heat exchanger can be directed to the stock filter mount fuel-out port.

9. The apparatus of claim 2 wherein said means is a valve.

10. The apparatus of claim 2 wherein said means comprises a tube for directing drainage.

11. The apparatus of claim 4 wherein the woven fabric has a weave specified to at least prevent particles larger than 2 microns from passing through it.

12. The apparatus of claim 4 wherein the support structure comprises one or both of a spiral winding and one open-formed wire mesh

13. The apparatus of claim 5 wherein the filter comprises a woven fabric portion and a support structure inside the woven fabric portion for maintaining it an open configuration, the woven fabric portion having a weave specified to at least prevent particles larger than 2 microns from passing through it.

14. The apparatus of claim 5 wherein the filter comprises a commercial filter of the type having a fastening element and the heat exchanger has a mating fastening element, and the fuel flow communication from the interior of the filter with the fuel output passage is through the fastening element.

15. The apparatus of claim 5 wherein the filter is removably attached by threads on a hollow fastening element on the filter mating with threads on the bottom of the heat exchanger and fuel flow communication from the interior of the filter with the fuel output passage is through the fastening element.

16. The apparatus of claim 8 wherein the heat transfer portion comprises a heat transfer body integral with the fuel heating chamber and adapted to have engine coolant flowing through it whereby heat from the engine coolant flowing through the heat transfer body is transferred to the fuel flowing through the fuel heating chamber.

17. The apparatus of claim 13 wherein the filter further comprises a hollow fastening element and the heat exchanger has a mating fastening element and the fuel flow communication from the interior of the filter with the fuel output line is through the hollow fastening element.

18. A method of conversion for a diesel engine to run on alternative fuel comprising;
installing in the fuel line from the fuel tank a combination heat exchanger and filter assembly comprising;
a heat exchanger having a path for the flow of coolant into and out of the heat exchanger and a fuel input line and a fuel output line;
a filter assembly mounted proximate the fuel heating chamber said filter comprising;
a transparent shell defining a filter space the filter space having an upper portion and a lower portion;
a filter mounted in the filter space at the upper portion thereof;
a collection space at the lower portion of the filter space;
the filter having fuel flow communication with the fuel input line in the heat exchanger to the filter space exteriorly of the filter and having fuel flow communication with the fuel output line of the heat exchanger from inside the filter;
whereby the heat exchanger operates to heat fuel flowing into and out of it, and incoming fuel passes from the heat exchanger into the filter space exteriorly of the filter and passes through the filter and back into the heat exchanger from the interior of the filter and exits the heat exchanger, whereby impurities and water are filtered from flow through the filter so that fuel passing to the fuel output line is purified and heated, and the collection of impurities in the filter can be observed.

19. The method of claim 18 further comprising;
installing the combination heat exchanger and filter upstream of the stock fuel filter;
having a fuel line from the fuel output line of the combination heat exchanger and filter to the stock fuel filter mount defining a fuel-in line to the stock fuel filter mount; and
substituting for the stock fuel filter by mounting on the stock filter mount, a heat exchanger having a fuel heating chamber adapted to receive incoming fuel from the stock fuel-in line in the filter mount and to exit outgoing fuel to the stock fuel-out line in the filter mount and a heat source in close proximity to the fuel heating chamber;
whereby heat from the heat source is transferred to the fuel flowing through the fuel heating chamber.

20. The method of claim 18 further comprising;
providing a booster fuel pump in a fuel line upstream of the combination heat exchanger and filter assembly.

21. The method of claim 19 wherein the heat source comprises one or more of engine coolant and an electrical heater.

22. A fuel supply system for operating a diesel engine on alternative fuel comprising;
a heat exchanger having a path for the flow of coolant into and out of the heat exchanger and a fuel input line and a fuel output line;
a filter assembly mounted proximate the fuel heating chamber said filter comprising;
a transparent shell defining a filter space the filter space having an upper portion and a lower portion;
a filter mounted in the filter space at the upper portion thereof;
a collection space at the lower portion of the filter space;
the filter assembly having fuel flow communication with the fuel input line in the heat exchanger to the filter space exteriorly of the filter and having fuel flow communication with the fuel output line of the heat exchanger from inside the filter;
whereby the heat exchanger operates to heat fuel flowing into and out of it, and incoming fuel passes from the heat exchanger into the filter space exteriorly of the filter and passes through the filter and back into the heat exchanger from the interior of the filter and exits the heat exchanger, whereby impurities and water are filtered from flow through the filter so that fuel passing to the fuel output line is purified and heated, and the collection of impurities in the filter can be observed;
a booster fuel pump in a fuel line upstream of the heat exchanger; and
at a stock fuel filter mount downstream of the heat exchanger, a conversion to either by-pass the stock fuel filter or substitute for the stock fuel filter a second heat exchanger through which fuel will flow.

23. An apparatus for conditioning alternative fuel in a conversion for operating a diesel engine on alternative fuel comprising;
a heat exchanger comprising;
a body portion made of a material having a high coefficient of heat transfer;
a coolant input port and a coolant output port and a coolant line extending between them within the heat exchanger body;
a fuel input port and a fuel input line extending therefrom in the heat exchanger body and ending at a filter input port;
a fuel output port and a fuel output line extending therefrom in the heat exchanger body and ending at a filter output port;
a filter assembly attached below the heat exchanger body comprising;
a transparent shell defining a filter space therein the filter space having an upper portion and a lower portion;
a filter in the filter space at the upper portion thereof the filter being attached to the heat exchanger body at an interior port that is in flow communication with the filter output port and such that the filter input port is in flow communication with the filter space exteriorly of the filter and the filter extending downwardly into the filter space;
a collection space at the lower portion of the filter space below the filter in the lower portion thereof;
a drain means at the bottom of the shell;
whereby coolant flowing through the heat exchanger will cause it to retain heat and fuel flowing from the fuel input port to the filter input port, and fuel flowing from the filter output port to the fuel output port will be heated as it flows inside the heat exchanger body to and from the filter assembly, and fuel will flow into the filter assembly exteriorly of the filter, pass through the filter and exit from interiorly of the filter into the heat exchanger and impurities will be filtered in the filter assembly shell outside the filter and at least a portion will collect at the bottom of the filter assembly and may be drained off through the drain valve.

24. A method of conversion for a diesel engine system to run on alternative fuel comprising;
adding between the system fuel tank and the engine a combination fuel heater and filter, the fuel heater and filter comprising a heat exchange member and a filter member, the heat exchange member having a coolant input and a coolant output for coolant and a coolant flow line so that coolant can flow through the heat exchanger and a fuel input and fuel output for fuel from the a fuel tank to flow through the heat exchanger
substituting for the stock fuel filter by mounting on the stock filter mount a heat exchanger having a fuel heating chamber adapted to receive incoming fuel from the stock fuel-in line in the filter mount and to exit outgoing fuel to the stock fuel-out line in the filter mount and a heat source in close proximity to the fuel heating chamber;
whereby heat from the heat source is transferred to the fuel flowing through the fuel heating chamber.

25. A method of conversion for a diesel engine system to run on alternative fuel comprising;
providing a combined heat exchanger and a filter assembly in a filter configuration having a transparent shell with a drain at its lower extremity and a filter inside the shell,
with a pump in the fuel line from the fuel tank, increasing fuel line pressure to the heat exchanger,
heating the fuel in a heat exchanger and sending it to the filter assembly,
filtering impurities in the transparent shell exteriorly of the filter,
causing the fuel to pass through the filter into its interior,
passing the filtered fuel through the heat exchanger,
passing the fuel to the engine fuel pump,
allowing periodic draining of collected impurities in the shell from via the drain valve.
